(19) United States
(12) Patent Application Publication
(10) Pub. No.: US 2008/0231192 A1
(43) Pub. Date: Sep. 25, 2008

(54) ELECTRON BEAM DRAWING APPARATUS

(75) Inventor: Munehiro Ogasawara, Hiratsuka-shi (JP)

Correspondence Address: Charles N.J. Ruggiero, Esq.;Ohlandt, Greeley, Ruggiero & Perle, L.L.P., One Landmark Square, 10th Floor, Stamford, CT, 06901-2682, US

(73) Assignee: Kabushiki Kaisha Toshiba

(21) Appl. No.: 12/033,467

(22) Filed: Feb. 19, 2008

(30) Foreign Application Priority Data
Mar. 19, 2007 (JP) 2007-071089

(51) Int. Cl. H01J 23/16

(52) U.S. Cl. 315/7

(57) ABSTRACT

An electron beam drawing apparatus, comprises an electrostatic deflector which deflects the electron beam by an electric field, a coaxial cable which is connected to deflecting electrodes, and a resistive element which is connected between a central conductor and an outer conductor or the external cylinder. The electrostatic deflector includes the external cylinder provided more downstream than the electron source and kept at the ground potential and a plurality of deflecting electrodes which are provided in the external cylinder. The coaxial cable includes the central conductor and the tubular outer conductor, one end of the central conductor passing through the external cylinder and being connected to the deflecting electrodes and one end of the outer conductor being connected to the external cylinder. The resistive element is set to a resistance for obtaining impedance matching with the coaxial cable.

### CROSS-REFERENCE TO RELATED APPLICATIONS

This application is based upon and claims the benefit of priority from prior Japanese Patent Application No. 2007-071089, filed Mar. 19, 2007, the entire contents of which are incorporated herein by reference.

### BACKGROUND OF THE INVENTION

1. Field of the Invention

This invention relates to an electron beam drawing apparatus which draws an LSI pattern on a specimen using an electron beam.

2. Description of the Related Art

In an electron beam drawing apparatus, an electrostatic deflector composed of a plurality of deflecting electrodes is used to deflect an electron beam. The deflector is for deflecting an electron beam by an electric field generated between the deflecting electrodes by applying to the deflecting electrodes a potential generated by a deflection amplifier.

One end of a coaxial cable is connected to the output end of the deflection amplifier. The other end of the coaxial cable is connected to the deflecting electrodes. Normally, since the deflecting electrodes are electrically connected only to the coaxial cable, it is conceivable that capacitive loads are connected to the tip of the coaxial cable in an equivalent circuit. Therefore, the signal input from the deflection amplifier to the deflecting electrode is almost totally reflected by the deflecting electrode and returns to the deflection amplifier with a specific time delay corresponding to the length of the coaxial cable, and again reflected by the deflection amplifier, which causes so-called ringing phenomenon. This phenomenon makes it difficult for the deflection amplifier to operate at high speed.

To overcome this problem, a method of connecting a coaxial cable connected to a terminating resistance to the deflecting electrodes apart from the coaxial cable connected to the deflection amplifier in order to suppress the reflection of the signal at the deflecting electrodes to achieve a high-speed operation has been proposed (e.g., JP-A H11-273603 (KOKAI)). Moreover, a method of connecting the coaxial cable connected to the deflection amplifier to the coaxial cable connected to a terminating resistance and then coupling the central conductor of the coaxial cable with the deflecting electrodes at the connections has been proposed (e.g., JP-A H11-176719 (KOKAI)). However, either method has the following problem: two coaxial cables have to be connected to one deflecting electrode, which makes the configuration complex.

### BRIEF SUMMARY OF THE INVENTION

According to an aspect of the invention, there is provided an electron beam drawing apparatus which forms a pattern by selectively applying an electron beam emitted from an electron source to a specimen, the electron beam drawing apparatus comprising: an electrostatic deflector which deflects the electron beam by an electric field and which includes an external cylinder provided more downstream than the electron source and kept at the ground potential, and a plurality of deflecting electrodes which are provided in the external cylinder and to each of which a deflecting voltage is applied; a coaxial cable unit including a plurality of coaxial cables which are connected to the deflecting electrodes, respectively, and each of which includes a central conductor and a tubular outer conductor surrounding the central conductor coaxially, one end of the central conductor passing through the external cylinder and being connected to corresponding one of the deflecting electrodes and one end of the outer conductor being connected to the external cylinder; and a resistive element which is connected between the central conductor and the outer conductor or the external cylinder in the vicinity of a junction between the central conductor and corresponding one of the deflecting electrodes and a resistance of which is set to a value for obtaining impedance matching the coaxial cable.

According to another aspect of the invention, there is provided an electron beam drawing apparatus which forms a pattern by selectively applying an electron beam emitted from an electron source to a specimen, the electron beam drawing apparatus comprising: an electrostatic deflector which deflects the electron beam by an electric field and which includes an external cylinder provided more downstream than the electron source and kept at the ground potential and a plurality of deflecting electrodes which are provided in the external cylinder and to each of which a deflecting voltage is applied; a coaxial cable unit having a plurality of coaxial cables which are connected to the deflecting electrodes, respectively, and each of which includes a central conductor and a tubular outer conductor surrounding the central conductor coaxially, one end of the central conductor passing through the external cylinder and being connected to corresponding one of the deflecting electrodes and one end of the outer conductor being connected to the external cylinder; and a resistive element which is connected between each of the deflecting electrodes and the outer conductor or the external cylinder in the vicinity of a junction between the central conductor and the corresponding one of the deflecting electrodes and which is formed into a tube whose diameter is almost the same as that of the outer conductor and a resistance of which is set to a value for obtaining impedance matching the coaxial cables.

According to still another aspect of the invention, there is provided an electron beam drawing apparatus which forms a pattern by selectively applying an electron beam emitted from an electron source to a specimen, the electron beam drawing apparatus comprising: an electrostatic deflector which deflects the electron beam by an electric field and which includes an external cylinder provided coaxially with respect to an axis of the electron beam and more downstream than the electron source and kept at the ground potential and a plurality of deflecting electrodes which are provided in the external cylinder so as to be symmetrical with respect to the axis of the electron beam and to each of which a deflecting voltage is applied; a coaxial cable unit having a plurality of coaxial cables which are connected to the deflecting electrodes, respectively, and each of which includes a central conductor and a tubular outer conductor surrounding the central conductor coaxially, one end of the central conductor passing through the external cylinder and being connected to corresponding one of the deflecting electrodes and the outer surface of one end of the outer conductor being connected to the external cylinder; and a resistive element which is inserted between the inner surface of one end of the outer conductor and the central conductor and which has its resistance set to almost the same as that of the characteristic impedance of the coaxial cable unit and which has the central conductor passing through its central part and has its outer surface formed into a ring making contact with the outer conductor.

### BRIEF DESCRIPTION OF THE SEVERAL VIEWS OF THE DRAWING

FIG. 1 schematically shows the configuration of an electron beam drawing apparatus according to a first embodiment of the invention;

FIG. 2 is a longitudinal sectional view schematically showing the configuration of an electrostatic deflector used in the electron beam drawing apparatus of FIG. 1;

FIG. 3 is a traverse sectional view schematically showing the configuration of the electrostatic deflector used in the electron beam drawing apparatus of FIG. 1;

FIG. 4 is an equivalent circuit diagram of the configuration shown in FIGS. 2 and 3;

FIG. 5 is a sectional view showing a modification of the first embodiment;

FIG. 6 is a sectional view showing another modification of the first embodiment;

FIGS. 7A and 7B are sectional views showing the configuration of the resistive element used in the electrostatic deflector shown in FIGS. 2 and 3;

FIG. 8 is a sectional view showing still another modification of the first embodiment;

FIG. 9 is an equivalent circuit diagram of the configuration shown in FIG. 8;

FIG. 10 is a sectional view schematically showing the configuration of an electrostatic deflector part according to a second embodiment of the invention;

FIG. 11 is a sectional view showing a modification of the second embodiment;

FIGS. 12A and 12B are sectional views schematically showing the configuration of an electrostatic deflector part according to a third embodiment of the invention; and

FIGS. 13A and 13B are sectional views schematically showing the configuration of an electrostatic deflector part according to a fourth embodiment of the invention.

### DETAILED DESCRIPTION OF THE INVENTION

Hereinafter, referring to the accompanying drawings, embodiments of the invention will be explained in detail.

### First Embodiment

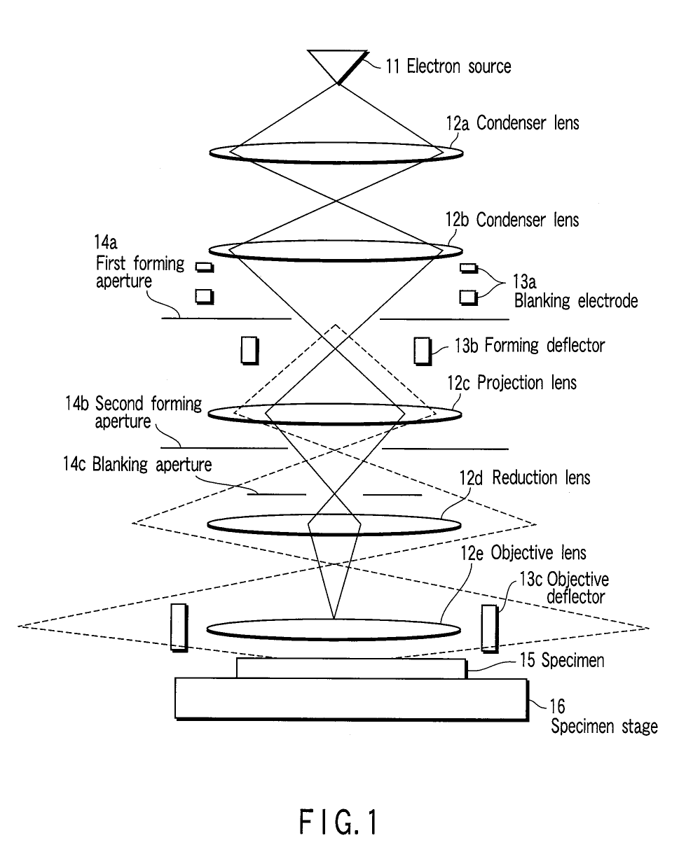

As shown in FIG. 1, an electron beam drawing apparatus according to a first embodiment of the invention comprises an electron gun 11, various lenses 12a to 12e, various deflectors 13a to 13c, various apertures 14a to 14c, and a specimen stage 16. A specimen is held in place on the specimen stage 16.

An electron beam emitted from the electron gun 11 at an accelerating voltage of 50 kV is condensed by condenser lenses 12a, 12b which are so excited that a crossover image coincides with a deflection fixed point of a shaping deflector 13b and is applied to a first shaping aperture 14a. A rectangular hole is made in the first shaping aperture 14a. A first forming beam passed through the aperture 14a has a rectangular cross-sectional shape.

The shaped electron beam shaped by the first shaping aperture 14a is focused by a projection lens 12c so excided that the image of the first shaping aperture 14a is formed on a second shaping aperture 14b and is applied to the second shaping aperture 14b. Here, the irradiated position on the second shaping aperture 14b can be changed by the shaping deflector 13b. In the second aperture 14b, openings of various shapes have been made. A beam is caused to pass through in a desired position of the second shaping aperture 14b, which enables an electron beam of a desired cross-sectional shape to be obtained.

The electron beam passed through the second shaping aperture 14b is focused by a reduction lens 12d and an objective lens 12e and reaches the surface of the specimen 15 placed on the specimen stage 16. At this time, the electron beam is deflected by an objective deflector 13c and reaches the desired position on the specimen 15.

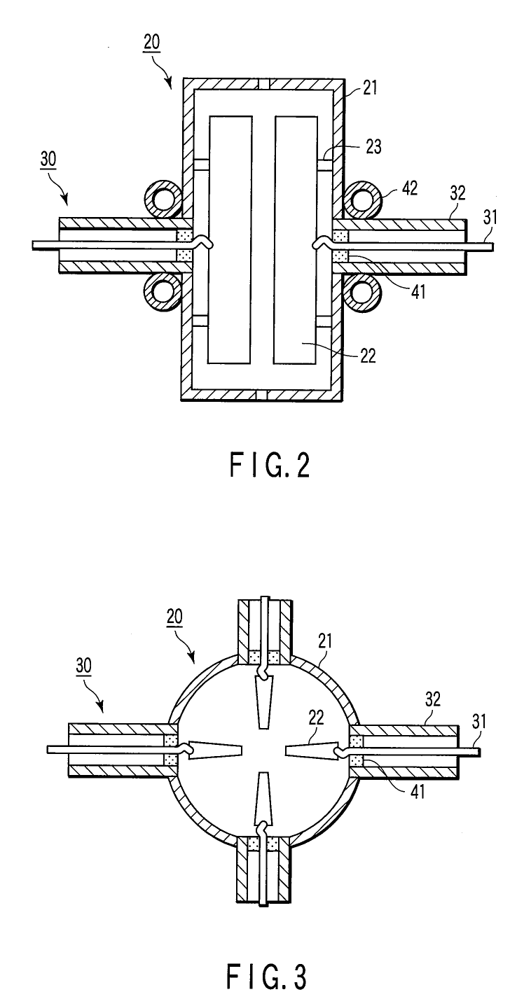

FIGS. 2 and 3 are diagrams to help explain the electrostatic deflector, such as the shaping deflector 13b, used in the apparatus. FIG. 2 is a longitudinal sectional view and FIG. 3 is a traverse sectional view.

In an external cylinder 21 provided coaxially with the axis of the electron beam, four deflecting electrodes 22 are arranged symmetrically with respect to the beam axis. These deflecting electrodes 22 are secured to the inner surface of the external cylinder 21 by a deflecting electrode fixing member 23 made of insulating material. The external cylinder 21, deflecting electrodes 22, and deflecting electrode fixing member 23 constitute an electrostatic deflector 20.

The external cylinder 21 has only to be basically a cylindrical body provided coaxially with the axis of the electron beam. In the first embodiment, to make the shield more reliable, disk members for closing the openings in the top surface and the bottom surface of the cylindrical body are provided. In the upper and lower disk members, holes to allow the electron beam to pass through are made.

Connected to the electrostatic defector 20 is a coaxial cable 30 which is composed of a central conductor 31 and an outer conductor 32 coaxially surrounding the conductor 31 and which is for supplying a deflecting voltage from a deflection amplifier (not shown). Specifically, a through hole is made in the side face of the external cylinder 21 of the electrostatic deflector 20. One end of the central conductor 31 of the coaxial cable 30 passes through the through hole and is connected to the deflecting electrode 22. The diameter of the through hole in the external cylinder 21 is made almost the same as the outer diameter of the outer conductor 32. One end of the outer conductor 32 is inserted into the hole in the external cylinder 21. One end side of the outer conductor 32 of the coaxial cable 30 is connected to the external cylinder 21 at the through hole part. A space between the central conductor 31 of the coaxial cable 30 and the outer conductor 32 is set as to be empty or is filled with dielectric material.

At the tip portion of the coaxial cable 30, a ring-shaped resistive element 41 is provided between the central conductor 31 and outer conductor 32. Specifically, the ring-shaped resistive element 41 is inserted into the outer conductor 32. The resistive element 41 has its central hole part connected to the central conductor 31 and its outer surface connected to the outer conductor 32. The resistance of the resistive element 41 is designed to be equal to the characteristic impedance of the coaxial cable 30, for example, 50 ohms. In the vicinity of the junction between the external cylinder 21 and the outer conductor 32 of the coaxial cable 30, a cooling pipe 42 is provided so as to surround the external cylinder 21.

Although the coaxial cable 30 using a metal pipe as the outer conductor 31 is preferable, the one using a metal mesh as the outer conductor 31 may be used. Fluorine resin is used as the dielectric material of the coaxial cable 30 and nonmagnetic copper material is used as the central conductor 31. The central conductor 31 which generates less gas and uses no nonmagnetic material is favorable. If the characteristic impedance of the coaxial cable 30 is Z ohms, it is often the case that reflection can be virtually neglected at a reflectivity coefficient of 10% or less. To meet this condition, it is desirable that the difference between the characteristic impedance of the coaxial cable 30 and the resistance of the resistive element 41 should be ±20% or less.

For example, the surface of a low-dielectric insulating material, such as fluorine resin, covered with a conductive film, such as a metal film or carbon film, can be used as the resistive element 41. The resistivity distribution at this time can be so designed that a part closer to the periphery of the resistive element 41 has a larger resistance, localizing the distributed heat source in the peripheral part, which facilitates cooling.

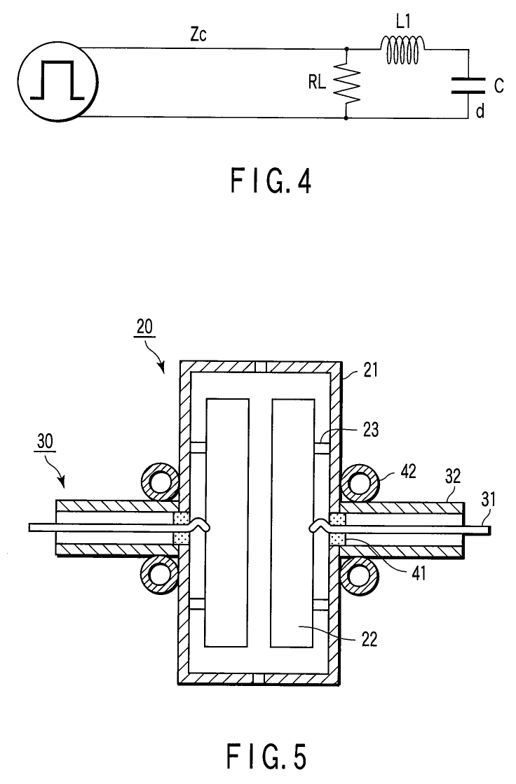

The deflecting electrodes 22 of the electrostatic deflector 20 are virtually isolated from the external cylinder 21 in the places excluding the junction with the central conductor 31 of the coaxial cable 30. Specifically, the deflecting electrode fixing member 23 as a mechanical support part is made of an insulating material or high-resistivity element whose resistance is sufficiently higher than 50 ohms. When this state is considered using an equivalent circuit diagram, it can be approximated by a circuit which includes resistance R_{L} whose resistance is the same as Z_{C} and capacitance Cd for the external cylinder 21 of the deflecting electrode 22 connected in parallel with lines whose characteristic impedance is Zc as shown in FIG. 4 and further includes inductance L1 inserted in series in the circuit.

Here, in a region of frequency f where the expression R_{L}<<1/(C_{d}2πf) holds, Cd can be ignored and the load can be regarded as R_{L} and therefore the signal is not reflected. On the other hand, even in such a high-frequency region as satisfies the expressions L₁C_{d}>>1/(2πf)² and L₁/R_{L}>>1/(2πf), although the load resistance can be regarded as R_{L}, it is not taken into account here because the frequencies in such a region are very high.

For example, if of the sides of one deflecting electrode 22, the dimensions of the part facing the external cylinder 21 connected to the ground are 5 mm×20 mm and the clearance between the part and the external cylinder 21 is 0.2 mm, the capacitance between the deflecting electrode 22 and the external cylinder 21 is about 5 pF. Suppose the capacitance between adjacent deflecting electrodes 22 is designed to be lower than about 5 pF and the capacitance of the deflecting electrode 22 is set to C_{d}=5 pF. Moreover, if inductance L₁=10 pH, this gives 1/(2π(L₁C_{d}f)^{-0.5})=22.5 GHz and R₁/(2πL₁)=1.6 GHz. Therefore, the effect of the inductance can be practically ignored. If f=100 MHz, the effect of the inductance can be ignored, giving 1/(C_{d}2πf)=318 ohms. The amplitude reflectivity is as low as 8%.

For such an approximation to hold, the central conductor 31 connecting the resistive element 41 and the deflecting electrode 22 should be shorter. Making the central conductor longer increases the frequency dependency of the impedance in the high-frequency region, which impairs the high-speed response. The analysis made by the inventor of the invention has shown that, when the rise time of the pulse from the deflection amplifier was set longer than L₁/R_{d} and C_{d}R₁, the rise of the voltage applied to the deflecting electrode 22 almost coincided with the rise of the pulse from the deflection amplifier, which made the reflection very small. In the above example, since L₁/R=0.1 ps and C_{d}R₁=250 ps, the rise time of the deflection amplifier is set to, for example, about 1 ns. In this case, too, the response is determined statically with an accuracy of 1.5×10⁻⁵ in about 11 ns.

The resistive element 41 is not necessarily provided between the central conductor 31 and the outer conductor 32. As shown in FIG. 5, the resistive element 41 may be provided between the central conductor 31 and the external cylinder 21. In FIG. 5, the diameter of the through hole in the external cylinder 21 is smaller than the outside diameter of the outer conductor 32. One end of the outer conductor 32 is connected to the outer surface of the external cylinder 21. Since the external cylinder 21 and outer conductor 32 are both grounded, the resistive element 41 may be connected to either of the two. Since it is desirable to connect resistance in a point closer to the junction with the deflecting electrode 22 of the central conductor 31, the resistive element 41 is connected to the outer conductor 21.

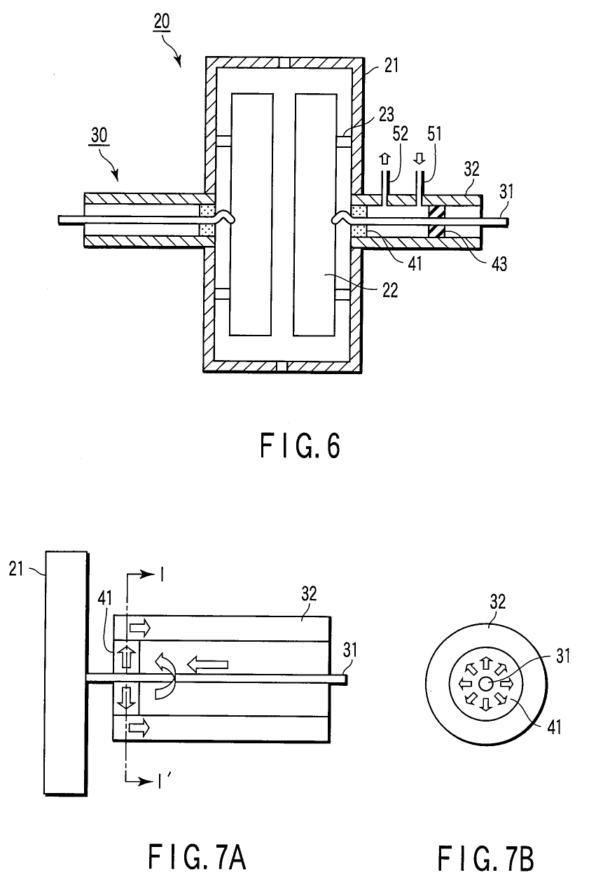

Furthermore, as shown in FIG. 6, cooling gas can be caused to flow in the outer conductor 32 by providing a gas supplying pipe 51 for supplying cooling gas to the outer conductor 32 and a gas exhaust pipe 52 which exhausts gas from the outer conductor 32 in the vicinity of the junction of the coaxial cable 30 with the deflector 20. At this time, the opening on the deflector side in the outer conductor 32 of the coaxial cable 30 is plugged with the resistive element 41 and a space between the central conductor 31 and the outer conductor 32 is filled with an insulating material 43 in a position far away from the gas supplying pipe 51 and gas exhaust pipe 52 on the deflector side. In addition, the resistive element 41 may be designed to have a two-layer structure having films on both surfaces of a thin dielectric material, thereby causing cooling gas to flow in the dielectric material.

Furthermore, the leakage of the magnetic field outside the coaxial cable can be reduced by providing a resistive material and a resistivity distribution so as to make the current flow in the resistive element 41 symmetrical with respect to the central conductor 31 as shown in FIGS. 7A and 7B. FIG. 7A is a sectional view of the coaxial cable 30 including a part of the electrostatic deflector 20. FIG. 7B is a sectional view taken along line I-I′ of FIG. 7A. With this configuration, since the resistive element 41 generates heat, the external cylinder 21 is provided with the cooling pipe 42 as shown in FIG. 2, thereby cooling the resistive element 41. To cool the resistive element 41 more efficiently, it is favorable to provide the cooling pipe 42 close to the coaxial cable 30.

The place in which the deflecting electrode 22 is fixed is set sufficiently away from the place where the coaxial cable 30 is connected and the junction of the central conductor 31 with the deflecting electrode 22 is bended slightly. By doing this, the influence of the expansion and contraction of the central conductor 31 caused by a temperature change in the resistive element 41 can be absorbed, which enables the mounting accuracy to be maintained. Making the central conductor 31 of bendable material enables the expansion and contraction of the central conductor 31 to be absorbed more efficiently.

As described above, with the first embodiment, one end of the central conductor 31 of the coaxial cable 30 is caused to pass through the external cylinder 21 and is connected to the deflecting electrode 22 of the electrostatic deflector 20, one end of the outer conductor 32 of the coaxial cable 30 is connected to the external cylinder 21, and the resistive element 41 is provided between the central conductor 31 and the outer conductor 32 in the vicinity of the junction of the central conductor 31 with the deflecting electrode 22. With this configuration, the reflection of the signal at the deflecting electrode 22 can be suppressed, which makes it possible to realize a high-speed operation of the electrostatic deflector 20. In this case, the configuration can be simplified-without increasing the number of coaxial cables 30 connected.

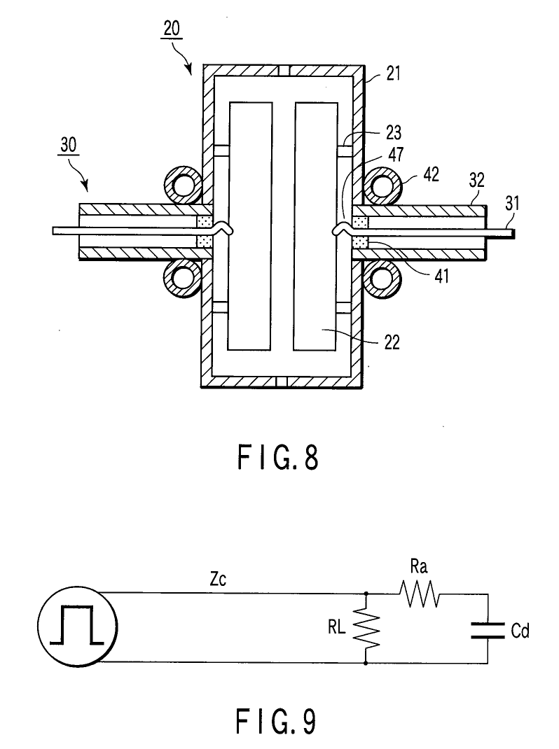

Furthermore, as shown in FIG. 8, the resistive element 47 is used as the junction of the central conductor 31 with the deflecting electrode 22, which is effective in suppressing reflection from the electrode at high speed. As seen from the equivalent circuit of FIG. 4, when the frequency f becomes very high and 2πc_{d}f becomes so large that it cannot be ignored as compared with 1/R_{L}, the reflection gets larger. To overcome this problem, using a resistive element as the junction of the central conductor 31 with the deflecting electrode 22 causes damping resistance Ra to be connected in series with Cd as shown in FIG. 9, which enables an increase in reflection in a high-frequency region to be suppressed. For example, if a resistance of Rₐ=2R_{L} is in the position L₁ when R_{L}=Z_{c} in FIG. 9, the reflectivity is 1.3 at a maximum. The reflection can be made lower by increasing Rₐ. However, the response time of the voltage at the electrode becomes longer in proportion to RₐC_{d}, it is preferable to increase Rₐ in a range where the response time accomplishes the purpose. If Rₐ=2Z_{c}=100 ohms and C_{d}=5 pF, since RₐC_{d} is 0.5 ns, this is admissible under the condition of a rise time of about 10 ns.

### Second Embodiment

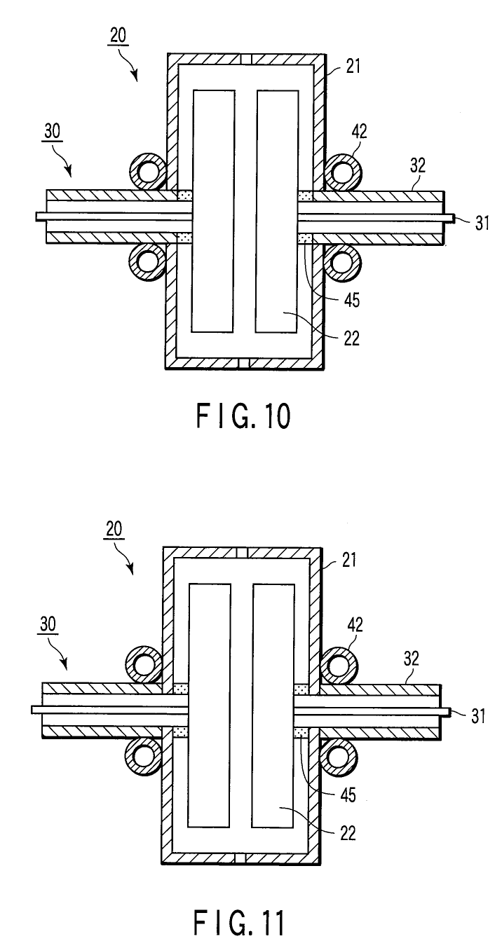

FIG. 10 is a sectional view schematically showing the configuration of an electrostatic deflector part according to a second embodiment of the invention. In FIG. 10, the same parts as those of FIG. 2 are indicated by the same reference numerals and a detailed explanation of them will be omitted.

The second embodiment differs from the first embodiment in the place where the resistive element is inserted. Specifically, in the second embodiment, the resistive element 45 is provided between the deflecting electrode 22 and the outer conductor 32 in the vicinity of the junction of the central conductor 31 with the deflecting electrode 22. The resistive element 45 has a cylindrical body whose diameter is almost the same as that of the outer conductor 32 of the coaxial cable 30. The resistance of the resistive element 45 is designed to be equal to the characteristic impedance of the coaxial cable 30, for example, 50 ohms.

Since the deflecting electrode 22 has the same potential as that of the central conductor 31, even if the resistive element 45 is provided between the deflecting electrode 32 and the outer conductor 32, the equivalent circuit is the same as in the first embodiment. However, since the resistive element 45 is provided in a place farther away from the junction of the central conductor 31 with the deflecting electrode 22, the high-speed response deteriorates. Therefore, the junction of the resistive element 45 with the deflecting electrode 22 should be close to the junction of the central conductor 31.

Furthermore, as shown in FIG. 11, in the configuration where the diameter of the through hole in the external cylinder 21 is smaller than the outside diameter of the outer conductor 32 and one end of the outer conductor 32 is connected to the outer surface of the external cylinder 21, the resistive element 45 may be provided between the deflecting electrode 22 and the external cylinder 21. In this case, too, the junction of the resistive element 45 with the deflecting electrode 22 should be close to the junction of the central conductor 31.

As described above, even if the resistive element 45 is provided between the deflecting electrode 22 and the outer conductor 32 or the external cylinder 21, not between the central conductor 31 and the outer conductor 32, this produces the same effect as that of the first embodiment. Moreover, in the second embodiment, the resistive element 45 may be used as the fixing member for the deflecting electrode 22, which provides the advantage of eliminating the deflecting electrode fixing member 23.

### Third Embodiment

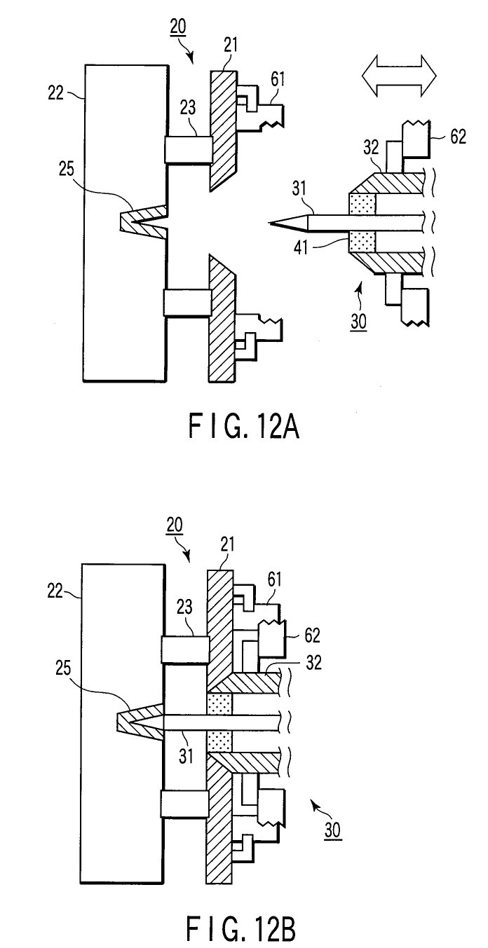

FIGS. 12A and 12B schematically show the configuration of an electrostatic deflector part according to a third embodiment of the invention. FIG. 12A is a sectional view showing a state before the deflector is mounted. FIG. 12B is a sectional view showing a state after the deflector is mounted. In FIGS. 12A and 12B, the same parts as those of FIG. 2 are indicated by the same reference numerals and a detailed explanation of them will be omitted.

The third embodiment is such that the coaxial cable 30 is configured to be installed on or removed from the electrostatic deflector 20 and the resistive element 41 is secured to the coaxial cable 30.

As shown in FIG. 12A, an opening in which the tip portion of the central conductor 31 of the coaxial cable 30 is to be inserted is made in the deflecting electrode 22. In the opening, a junction member 25 is provided to reduce the contact resistance with the central conductor 31. In the coaxial cable 30, the end of the central conductor 31 protrudes over the outer conductor 32 and the resistive element 41 is provided between the outer conductor 32 and the central conductor 31. A screw 62 is secured to the outer surface of the coaxial cable 30 and a screw 61 capable of joining with the screw 62 is provided in the vicinity of the cable connection hole in the external cylinder 21 so as to rotate freely.

As shown in FIG. 12B, the coaxial cable 30 passes through the cable connection hole in the external cylinder 21 and moves to the deflecting electrode 22 side and is secured to the external cylinder 21 by fastening the screws 61, 62. At this time, the tip portion of the central conductor 31 makes contact with the junction member 25 of the deflecting electrode 22 and the outer conductor 32 comes into contact with the external cylinder 21.

Accordingly, in the state of FIG. 12B, the third embodiment has basically the same configuration as that of FIG. 2 and produces the same effect as that of the first embodiment. In the third embodiment, since the resistive element 41 is integrated into the coaxial cable 30, it has the advantage that the manufacture of the deflecting electrode side becomes easier.

### Fourth Embodiment

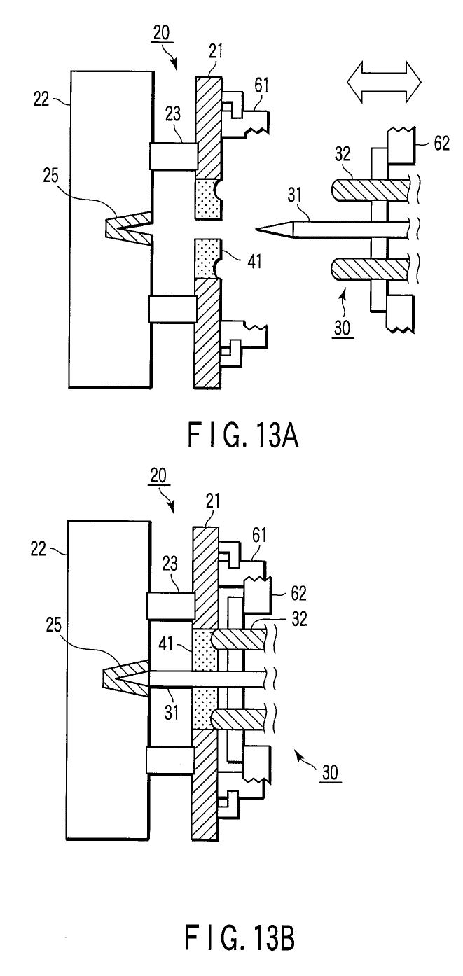

FIGS. 13A and 13B schematically show the configuration of an electrostatic deflector part according to a fourth embodiment of the invention. FIG. 13A is a sectional view showing a state before the deflector is mounted. FIG. 13B is a sectional view showing a state after the deflector is mounted. In FIGS. 13A and 13B, the same parts as those of FIGS. 12A and 12B are indicated by the same reference numerals and a detailed explanation of them will be omitted.

The fourth embodiment is such that the coaxial cable 30 is configured to be installed on or removed from the electrostatic deflector 20 and the resistive element 41 is secured to the external cylinder 21.

As shown in FIG. 13A, an opening in which the tip portion of the central conductor 31 of the coaxial cable 30 is to be inserted is made in the deflecting electrode 22. In the opening, a junction member 25 is provided to reduce the contact resistance with the central conductor 31. A ring-shaped resistive element 41 with a hole in its central part in which the central conductor 31 of the coaxial cable is to be inserted is secured to the cable connection hole in the external cylinder 21 in which the coaxial cable 30 is to be inserted.

As shown in FIG. 13B, the coaxial cable 30 passes through the cable connection hole in the external cylinder 21 and moves to the deflecting electrode 22 side and is secured to the external cylinder 21 by fastening the screws 61, 62. At this time, the tip portion of the central conductor 31 makes contact with not only the junction member 25 of the deflecting electrode but also the resistive element 41 provided in the opening in the external cylinder 21. Moreover, the outer conductor 32 of the coaxial cable 30 comes into contact with the peripheral part of the resistive element 41 and the external cylinder 21.

Accordingly, in the state of FIG. 13B, the fourth embodiment has basically the same configuration as that of FIG. 2 and produces the same effect as that of the first embodiment. In the fourth embodiment, since the resistive element 41 is integrated into the external cylinder 21, it has the advantage that the coaxial cable 30 need not be modified at all and therefore an ordinary cable can be used as it is.

(Modification)

The invention is not limited to the above embodiments. The configuration of the optical system of the electron beam drawing apparatus is not restricted to that of FIG. 1 and may be modified suitably according to the specification. While in the embodiments, the invention has been applied to a forming deflector for forming a beam, it is not limited to such a deflector. For instance, the invention may be applied to any electrostatic deflector which deflects deflecting a beam by an electric field. Moreover, the number of deflecting electrodes is not limited to 4 and may be 8 or another number.

Furthermore, the shape and material of the resistive element may be changed suitably according to the specification. Moreover, the position in which the resistive element is provided is not restricted to the places shown in the embodiments. The resistive element may be provided in any position in the vicinity of the junction between the central conductor and the deflecting electrode. In addition, the damping resistance may be a part of the electrode in the vicinity of the junction of the central conductor, provided that the damping resistance is in parallel with the resistive element in an equivalent circuit. For example, the junction member 25 may be made of a resistive material in FIGS. 12A and 12B and FIGS. 13A and 13B.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electron beam drawing apparatus which forms a pattern by selectively applying an electron beam emitted from an electron source to a specimen, comprising:
an electrostatic deflector which deflects the electron beam by an electric field and which includes an external cylinder provided more downstream than the electron source and kept at the ground potential, and a plurality of deflecting electrodes which are provided in the external cylinder and to each of which a deflecting voltage is applied;
a coaxial cable unit including a plurality of coaxial cables which are connected to the deflecting electrodes, respectively, and each of which includes a central conductor and a tubular outer conductor surrounding the central conductor coaxially, one end of the central conductor passing through the external cylinder and being connected to corresponding one of the deflecting electrodes and one end of the outer conductor being connected to the external cylinder; and
a resistive element which is connected between the central conductor and one of the outer conductor and the external cylinder in the vicinity of a junction of the central conductor with corresponding one of the deflecting electrodes and a resistance of which is set to a value for obtaining impedance matching the coaxial cable.

2. The apparatus according to claim 1, wherein the resistance of the resistive element is almost equal to a characteristic impedance of the coaxial cable unit.

3. The apparatus according to claim 1, wherein the resistive element is formed into a ring shape which has the central conductor passing through its central part and has its outer surface making contact with the outer conductor or the external cylinder.

4. The apparatus according to claim 3, wherein the resistive element has a resistivity distribution so determined that current flowing in the resistive element is symmetrical with respect to the axis of the central conductor.

5. The apparatus according to claim 1, wherein a cooling mechanism for cooling the external cylinder is provided in the vicinity of the junction of the external cylinder with the outer conductor.

6. The apparatus according to claim 1, wherein a cooling mechanism for causing cooling fluid to flow in a space between the central conductor and the outer conductor is provided on the electrostatic deflector side of the coaxial cable unit.

7. The apparatus according to claim 1, wherein the junction of the central conductor with the corresponding one of the deflecting electrodes is made of a bendable member.

8. The apparatus according to claim 1, wherein each of the deflecting electrodes is secured to the external cylinder by a deflecting electrode fixing member made of insulating material.

9. The apparatus according to claim 1, wherein a tip portion of each of the coaxial cable unit is removable with respect to the electrostatic deflector and, when the coaxial cable is installed on the electrostatic deflector, the central conductor makes contact with the corresponding one of the deflecting electrodes and the outer conductor comes into contact with the external cylinder.

10. The apparatus according to claim 7, wherein the resistive element is secured to a part of the external cylinder through which the central conductor of the corresponding one of the coaxial cables passes and, when the coaxial cable unit is installed on the electrostatic deflector, the resistive element makes contact with the central conductor of the corresponding one of the coaxial cables.

11. An electron beam drawing apparatus which forms a pattern by selectively applying an electron beam emitted from an electron source to a specimen, comprising:
an electrostatic deflector which deflects the electron beam by an electric field and which includes an external cylinder provided more downstream than the electron source and kept at the ground potential and a plurality of deflecting electrodes which are provided in the external cylinder and to each of which a deflecting voltage is applied;
a coaxial cable unit having a plurality of coaxial cables which are connected to the deflecting electrodes, respectively, and each of which includes a central conductor and a tubular outer conductor surrounding the central conductor coaxially, one end of the central conductor passing through the external cylinder and being connected to corresponding one of the deflecting electrodes and one end of the outer conductor being connected to the external cylinder; and
a resistive element which is connected between each of the deflecting electrodes and one of the outer conductor and the external cylinder in the vicinity of a junction of the central conductor with the corresponding one of the deflecting electrodes and which is formed into a tube whose diameter is almost the same as that of the outer conductor and a resistance of which is set to a value for obtaining impedance matching the coaxial cables.

12. The apparatus according to claim 11, wherein the resistance of the resistive element is almost equal to a characteristic impedance of the coaxial cable unit.

13. The apparatus according to claim 11, wherein a cooling mechanism for cooling the external cylinder is provided in the vicinity of the junction of the external cylinder with the outer conductor.

14. The apparatus according to claim 11, wherein a cooling mechanism for causing cooling fluid to flow in a space between the central conductor and the outer conductor is provided on the electrostatic deflector side of the coaxial cable unit.

15. The apparatus according to claim 11, wherein the junction of the central conductor with the corresponding one of the deflecting electrodes is made of a bendable member.

16. The apparatus according to claim 11, wherein the deflecting electrodes are secured to the external cylinder by a deflecting electrode fixing member made of insulating material.

17. The apparatus according to claim 11, wherein a tip portion of the coaxial cable unit is removable with respect to the electrostatic deflector and, when the coaxial cable unit is installed on the electrostatic deflector, the central conductor makes contact with the deflecting electrodes and the outer conductor comes into contact with the external cylinder.

18. The apparatus according to claim 15, wherein the resistive element is secured to a part of the external cylinder through which the central conductor of each of the coaxial cables passes and, when the coaxial cable is installed the electrostatic deflector, the resistive element makes contact with the central conductor of the corresponding one of the coaxial cables.

19. An electron beam drawing apparatus which forms a pattern by selectively applying an electron beam emitted from an electron source to a specimen, comprising:
an electrostatic deflector which deflects the electron beam by an electric field and which includes an external cylinder provided coaxially with respect to an axis of the electron beam and more downstream than the electron source and kept at the ground potential and a plurality of deflecting electrodes which are provided in the external cylinder so as to be symmetrical with respect to the axis of the electron beam and to each of which a deflecting voltage is applied;
a coaxial cable unit having a plurality of coaxial cables which are connected to the deflecting electrodes, respectively, and each of which includes a central conductor and a tubular outer conductor surrounding the central conductor coaxially, one end of the central conductor passing through the external cylinder and being connected to corresponding one of the deflecting electrodes and the outer surface of one end of the outer conductor being connected to the external cylinder; and
a resistive element which is inserted between the inner surface of one end of the outer conductor and the central conductor and which has its resistance set to almost the same as that of the characteristic impedance of the coaxial cable unit and which has the central conductor passing through its central part and has its outer surface formed into a ring making contact with the outer conductor.
